(19) United States
(12) Patent Application Publication
(10) Pub. No.: US 2025/0353526 A1
(43) Pub. Date: Nov. 20, 2025

(54) SYSTEMS AND METHODS FOR IDENTIFYING DRIVABLE LANE CORRIDORS

(71) Applicant: Torc Robotics, Inc., Blacksburg, VA (US)

(72) Inventors: Harish Pullagurla, Manor, TX (US); Garrett Madsen, Austin, TX (US); Paul Joseph Brown, Roanoke, VA (US); Jason Harper, Upper Arlington, OH (US)

(21) Appl. No.: 18/666,507

(22) Filed: May 16, 2024

(51) Int. Cl. B60W 60/00

(52) U.S. Cl. CPC B60W 60/0011; B60W 2420/40; B60W 2552/50

(57) ABSTRACT

A path determination system is provided. The path determination system includes a processor and a memory. The processor is configured to receive sensor data from one or more sensors of an autonomous vehicle, identify, based on the sensor data, (i) one or more forward travel lanes and (ii) one or more objects, determine the one or more objects form a barrier indicating closure of all of the one or more forward travel lanes, when the barrier indicates closure of all of the one or more forward travel lanes, determine an alternative travel path for the autonomous vehicle, and control the autonomous vehicle to travel the alternative travel path.

### TECHNICAL FIELD

The field of the disclosure relates generally to autonomous vehicles and, more specifically, to systems and methods for identifying drivable travel corridors for autonomous vehicles in construction or other lane closure situations.

### BACKGROUND OF THE INVENTION

During construction or other road closure events, some are all of the normal travel lanes of a road may be blocked. In such situations, vehicles may be expected to drive on a shoulder of the road or some other alternative corridor. When a road is blocked in this way, known autonomous vehicles generally are prevented from traveling further, because autonomous vehicles are generally configured to maintain a path within a travel lane. An autonomous vehicle capable of recognizing and traveling in situations in which some are all of the normal travel lanes of a road are blocked is therefore desirable.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, a path determination system is provided. The path determination system includes a processor and a memory. The processor is configured to receive sensor data from one or more sensors of an autonomous vehicle, identify, based on the sensor data, (i) one or more forward travel lanes and (ii) one or more objects, determine the one or more objects form a barrier indicating closure of all of the one or more forward travel lanes, when the barrier indicates closure of all of the one or more forward travel lanes, determine an alternative travel path for the autonomous vehicle, and control the autonomous vehicle to travel the alternative travel path.

In another aspect, a method for path determination is provided. The method includes receiving sensor data from one or more sensors of an autonomous vehicle, identifying, based on the sensor data, (i) one or more forward travel lanes and (ii) one or more objects, determining the one or more objects form a barrier indicating closure of all of the one or more forward travel lanes, when the barrier indicates closure of all of the one or more forward travel lanes, determining an alternative travel path for the autonomous vehicle, and controlling the autonomous vehicle to travel the alternative travel path.

In yet another aspect, an autonomous vehicle is provided. The autonomous vehicle includes one or more sensors and a path determination system including a processor and a memory. The processor is configured to receive sensor data from the one or more sensors, identify, based on the sensor data, (i) one or more forward travel lanes and (ii) one or more objects, determine the one or more objects form a barrier indicating closure of all of the one or more forward travel lanes, when the barrier indicates closure of all of the one or more forward travel lanes, determine an alternative travel path for the autonomous vehicle, and control the autonomous vehicle to travel the alternative travel path.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an autonomous vehicle;

FIG. 2 is a block diagram of an autonomous vehicle;

FIG. 3 depicts an example path determination case using the autonomous vehicle shown in FIGS. 1 and 2;

FIG. 4 is a continuation of the example path determination case shown in FIG. 3;

FIG. 5 is a continuation of the example path determination case shown in FIGS. 3 and 4;

FIG. 6 is a continuation of the example path determination case shown in FIGS. 3-5;

FIG. 7 is a continuation of the example path determination case shown in FIGS. 3-6;

FIG. 8 is a flow chart of an example method for path determination using the autonomous vehicle shown in FIGS. 1 and 2; and

FIG. 9 is a block diagram of an example computing device.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

Embodiments of the disclosed system determine a path for an autonomous vehicle in situations where all of the forward travel lanes of a road on which the autonomous vehicle is traveling are at least partially blocked or closed. In the example embodiment, the autonomous vehicle may include or otherwise be in communication with a path determination system. The path determination system is configured to receive sensor data from one or more sensors of the autonomous vehicle and identify, based on the sensor data, (i) one or more forward travel lanes and (ii) one or more objects. The objects may include, for example, traffic cones, traffic barrels, or other objects used to indicate that a lane or portion of a road is closed.

In the example embodiment, the path determination system is configured to determine the one or more objects form a barrier. For example, the path determination system may determine that a series of traffic barrels in a line is intended to form a barrier that vehicles should not cross. In this situation, a typical object avoidance system would not prevent the autonomous vehicle from crossing the intended barrier if the traffic barrels are spaced sufficiently far apart for the autonomous vehicle to pass through. Thus, by identifying such implied barriers, the path determination system is capable of preventing the autonomous vehicle from entering closed portions, such as closed lanes, of roadways.

When the identified barrier indicates closure of all of the one or more forward travel lanes of the road, the path determination system is configured to determine an alternate travel path for the autonomous vehicle. For example, if a shoulder of the road provides a sufficiently wide path, an alternative travel path may be identified that utilizes at least a portion of the shoulder of the road. When the path determination system is able to determine an alternative travel path for the autonomous vehicle, the path determination system controls the autonomous vehicle to travel the alternative travel path until reaching an end of the closure, at which point the autonomous vehicle may resume travel in the forward travel lanes. If the path determination system is unable to identify an adequate alternative travel path, the path determination system controls the autonomous vehicle to stop or move to a safe location. In cases where the barrier indicates at least one lane is closed but at least one other lane remains open, the path determination system may control the autonomous vehicle to travel in the open lane.

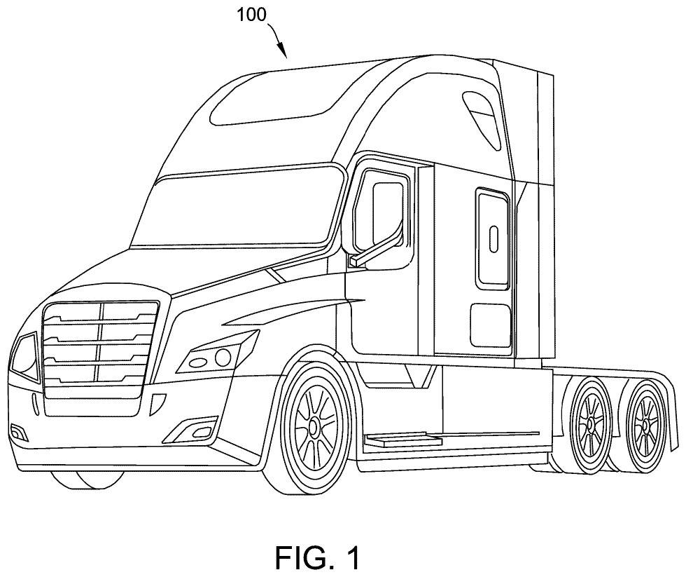

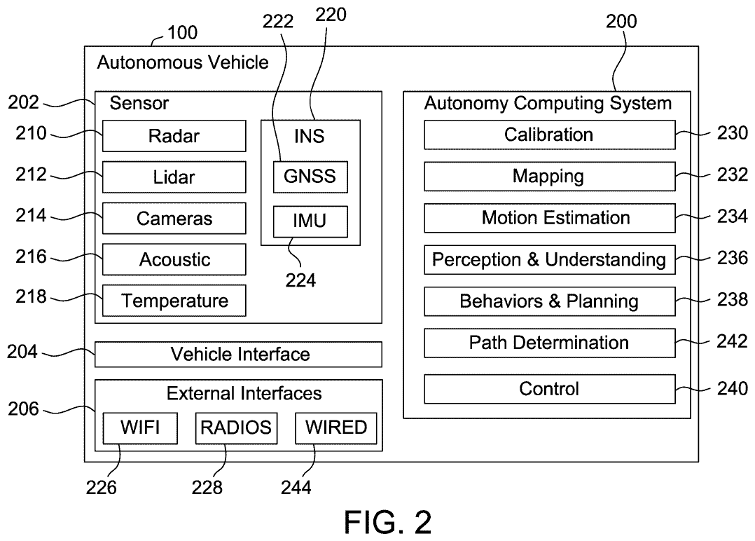

FIG. 1 is a schematic diagram of an autonomous vehicle 100. FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 120 to determine how to control operation of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be stitched or combined to generate a visual representation of the multiple cameras' FOVs, which may be used to, for example, generate a bird's eye view of the environment surrounding autonomous vehicle 100. In some embodiments, the image data generated by cameras 214 may be sent to autonomy computing system 200 or other aspects of autonomous vehicle 100, and this image data may include autonomous vehicle 100 or a generated representation of autonomous vehicle 100. In some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. Radar sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be fused or used in combination to determine conditions (e.g., locations of other objects) around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and a path determination module 242. Path determination module 242, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Path determination module 242 maintains proper lane position for autonomous vehicle 100 in all conditions, e.g., regardless of signage for given road conditions. Path determination module 242 receives, for example, positions of left or right lane markings from perception and understanding module 236 and computes a lane position offset from the identified lane marking. Where both left and right lane markings are detected by perceptions and understanding module 236, in combination with sensors 202, path determination module 242 selects one lane marking from which lane positioning is derived. Based on identified lane markings, path determination module 242 is configured to identify one or more forward travel lanes, or lanes of the road on which autonomous vehicle 100 is traveling appropriate for autonomous vehicle 100 to travel along its intended route. In some cases, these forward travel lanes may be closed or obstructed, in which case path determination module 242 is configured to identify an alternative path, as described in further detail below.

In the example embodiment, path determination module 242 is configured to determine one or more objects identified, for example, by perception and understanding module 236 form a barrier indicating closure of one or more of the one or more forward travel lanes. For example, the one or more objects may include traffic cones, traffic barrels, barrier boards, signs, bollards, or other objects that when placed in sequence for a physical or implied barrier. The nature of the one or more objects themselves (e.g., whether the object is intended to be a traffic indicator or is on the road errantly), the positions of the one or more objects with respect to the travel lanes, and the positions of the objects with respect to each other may all be considered to determine whether the objects form a barrier. In some situations, the objects may be spaced sufficiently far that autonomous vehicle 100 can pass through without colliding with the objects. In these cases, the ability to recognize that the objects form a barrier enables autonomous vehicle 100 to avoid traveling into a closed area of the road even when normal object avoidance would not prevent autonomous vehicle 100 from passing into that area.

For example, traffic cones marking potholes may be placed in an irregular pattern, which may not be identified as a barrier. In this case, autonomous vehicle 100 may continue to travel substantially in the same forward travel lane while avoiding collision with the traffic cones. Alternatively, if the traffic cones are arranged in a line to block a forward travel lane and direct traffic to an adjacent lane, autonomous vehicle 100 may identify the traffic cones as forming a barrier and travel to the adjacent lane.

In the example embodiment, when the barrier indicates all of the forward travel lanes of the road on which autonomous vehicle 100 is traveling are closed, path determination module 242 is configured to determine whether an alternative travel path for the autonomous vehicle is present. For example, in some embodiments, path determination module 242 is configured to determine whether a road shoulder is adequate for forward travel of the autonomous vehicle. To make this determination, path determination module 242 may consider whether a width of the shoulder, or the shoulder in combination with any available pavement of the forward travel lanes, satisfies a threshold width. In some embodiments, path determination model 242 also considers travel paths of other vehicles to determine whether an alternative travel path is available. For example, path determination module 242 may identify a travel path of one or more other vehicles preceding the autonomous vehicle and determine the travel path of the one or more other vehicles is adequate for forward travel of the autonomous vehicle (e.g., it is wide enough and has an appropriate driving surface). If so, autonomous vehicle 100 can follow the preceding vehicles on this path. In certain embodiments, other factors, such as temporary lane markings, signage, or gestures made by workers are considered to determine whether a shoulder of other path is adequate for travel.

When an adequate alternative travel path for the autonomous vehicle is present, autonomous vehicle 100 is controlled to travel the alternative travel path. On the other hand, if an adequate alternative travel path for the autonomous vehicle is present autonomous vehicle 100 is controlled to stop at a safe location, determine an alternate route, or communicate to a local or remote human operator that autonomous vehicle 100 is unable to travel further.

In some embodiments, in cases where multiple forward travel lanes are present, path determination model 242 is configured to determine whether all of the forward travel lanes are closed based on the presence of a barrier. If less than all of the forward travel lanes are closed (i.e., some remain open), autonomous vehicle 100 is controlled to travel in an open travel lane and avoid the closed travel lanes.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

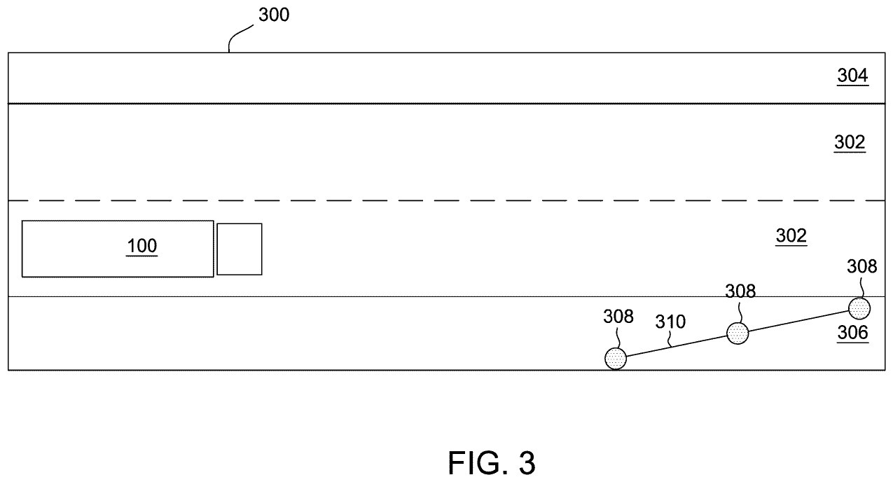

FIGS. 3-7 illustrate an example case in which autonomous vehicle 100 determines a drivable travel corridor in a lane closure situation. Referring to FIG. 3, autonomous vehicle 100 travels on a road 300 having two forward travel lanes 302, a left shoulder 304, and a right shoulder 306. Using autonomy computing system 200 as described above, autonomous vehicle 100 identifies three objects 308 in right shoulder 306. Objects 308 may be, for example, traffic cones or barrels. Based on the relative positions of objects 308, autonomous vehicle 100 determines objects 308 form a barrier 310 closing right shoulder 306. It is noted that barrier 310 does not necessarily exist as a physical or visible barrier on road 300, but can be inferred based on the positions of objects 308.

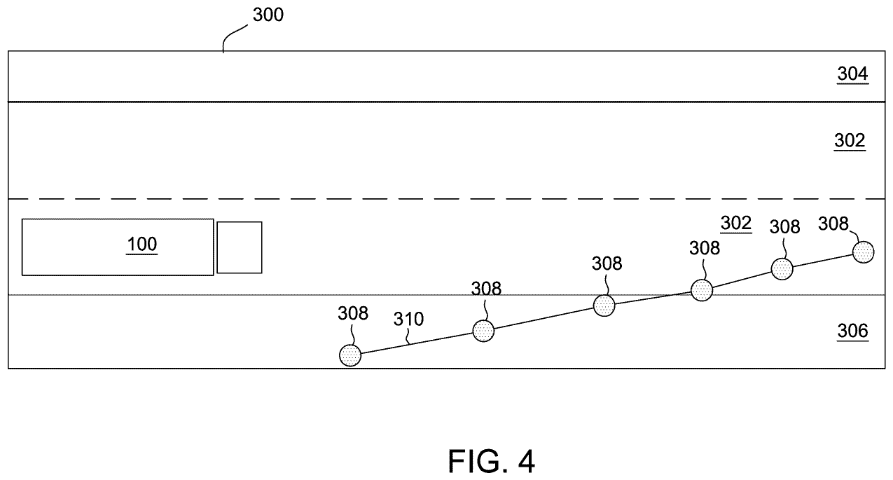

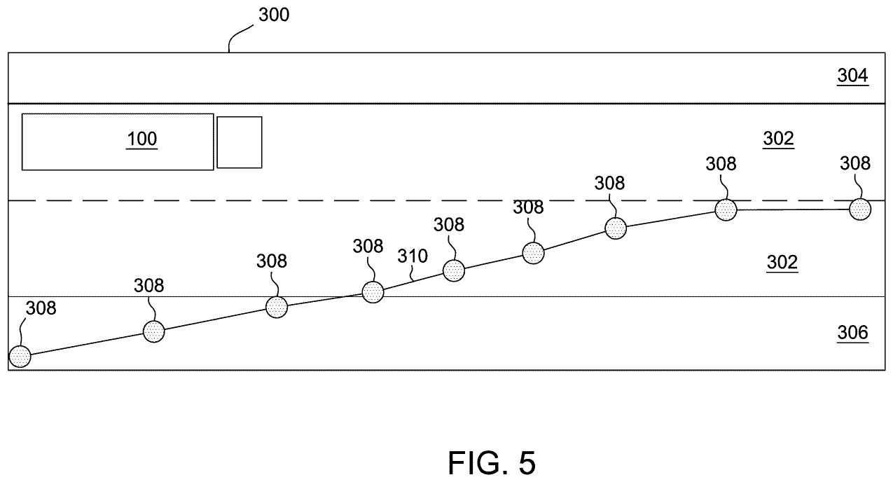

As shown in FIG. 4, autonomous vehicle 100 identifies three additional objects 308 in one of forward travel lanes 302. Based on the relative positions of the six visible objects 308, autonomous vehicle 100 determines that barrier 310 extends into this forward travel lane 302. In response, autonomous vehicle 100 determines this forward travel lane 302 is closed and moves into the other forward travel lane 302, as shown in FIG. 5.

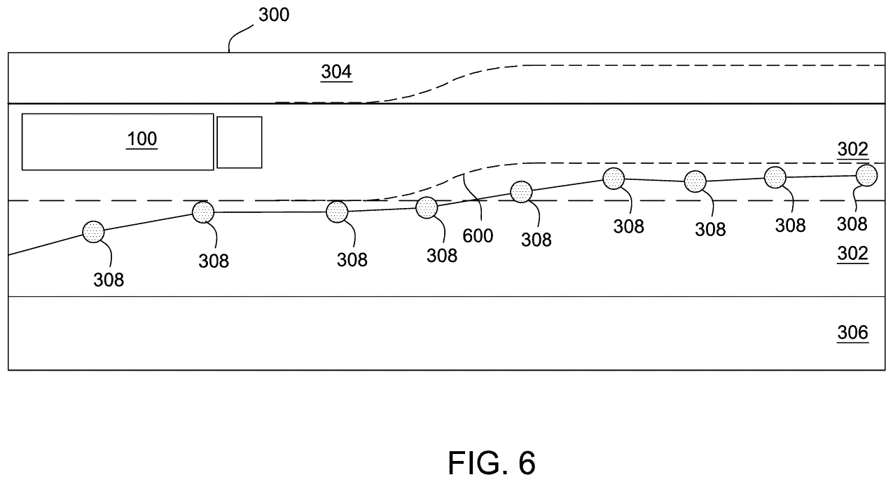

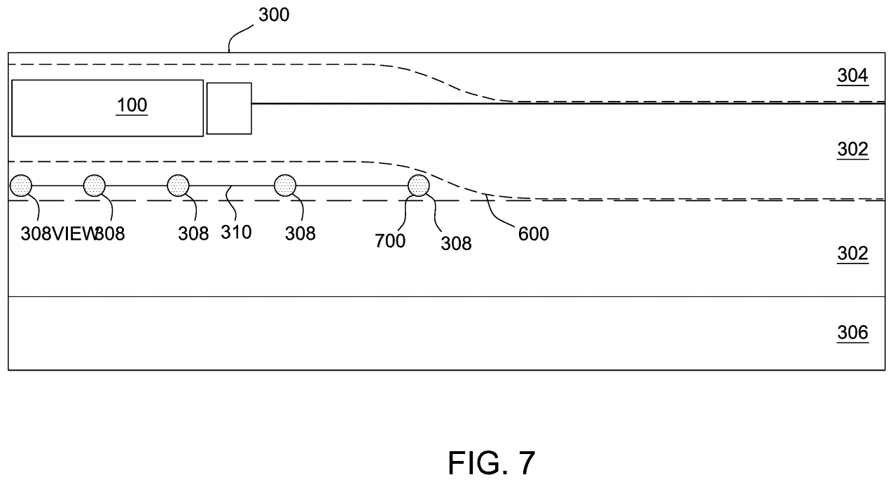

Referring to FIG. 6, autonomous vehicle 100 identifies additional objects in the remaining forward travel lane 302, and determines that barrier 310 extends partially into the remaining forward travel lane 302. Thus, autonomous vehicle 100 determines it is not possible to follow a path that lies completely within the forward travel lanes 302. Because left shoulder 304 together with the remaining portion of forward travel lane 302 is sufficiently wide to accommodate autonomous vehicle 100, autonomous vehicle 100 identifies an alternative travel path 600 utilizing left shoulder 304 and the available portion of forward travel lane 302. In some embodiments, autonomous vehicle filters a variability in position of barrier 310 to follow a smooth path. For example, as shown in FIG. 6, objects 308 are slightly askew in the lateral direction, causing barrier 310 to follow a jagged path, while alternate travel path 600 is substantially straight. As shown in FIG. 7, autonomous vehicle 100 follows alternative travel path 600 and, upon recognizing an end 700 of barrier 310, resumes traveling in forward travel lanes 302 after passing end 700.

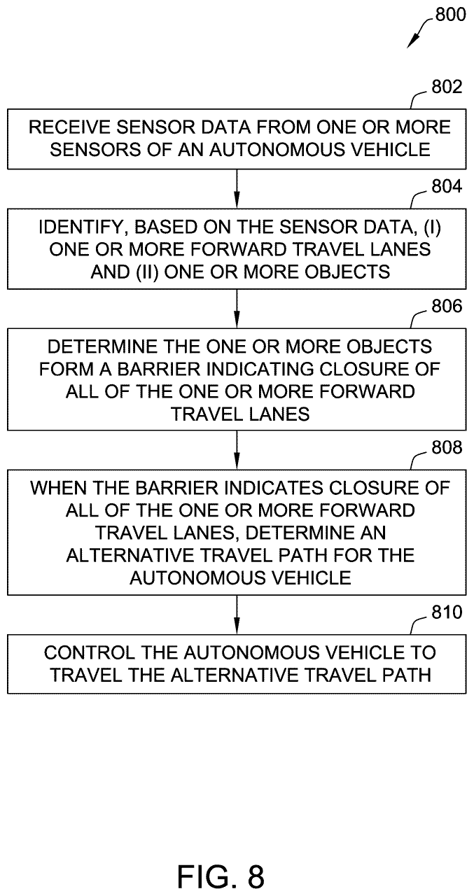

FIG. 8 is a flowchart of an example method 800 for path determination in lane closure situations. Method 800 may be performed, for example, by autonomy computing system 200 of autonomous vehicle 100.

In the example embodiment, autonomy computer system 200 receives 802 sensor data from one or more sensors 202 of autonomous vehicle 100. Autonomy computer system 200 further identifies 804, based on the sensor data, (i) one or more forward travel lanes (such as forward travel lanes 302) and (ii) one or more objects (such as objects 308). Autonomy computer system 200 further determines 806 the one or more objects form a barrier (such as barrier 310) indicating closure of all of the one or more forward travel lanes. Autonomy computer system 200, when the barrier indicates closure of all of the one or more forward travel lanes, further determines 808 an alternative travel path (such as alternative travel path 600) for autonomous vehicle 100. Autonomy computer system 200 further controls 810 autonomous vehicle 100 to travel the alternative travel path.

In some embodiments, autonomy computer system 200 further, when an alternative travel path for the autonomous vehicle is not present, controls autonomous vehicle 100 to stop.

In some embodiments, autonomy computer system 200 further, while controlling autonomous vehicle 100 to travel the alternative travel path, identifies an end (such as end 700) of the closure of all of the one or more forward travel lanes and controls autonomous vehicle 100 to travel in one of the one or more forward travel lanes at the end of the closure.

In some embodiments, autonomy computer system 200 further determines the one or more forward travel lanes includes a plurality of forward travel lanes and, when the barrier indicates closure of less than all of the plurality of forward travel lanes, controls the autonomous vehicle to travel in an open travel lane of the plurality of forward travel lanes.

In some embodiments, autonomy computer system 200, to determine the alternative travel path for autonomous vehicle 100, determines a road shoulder is adequate for forward travel of autonomous vehicle 100.

In some embodiments, autonomy computer system 200, to determine the alternative travel path for autonomous vehicle 100, identifies a travel path of one or more other vehicles preceding autonomous vehicle 100 and determines the travel path of the one or more other vehicles is adequate for forward travel of autonomous vehicle 100.

In some embodiments, autonomy computer system 200, to determine the alternative travel path for autonomous vehicle 100, determines a candidate alternative travel path includes a paved portion satisfying a threshold width.

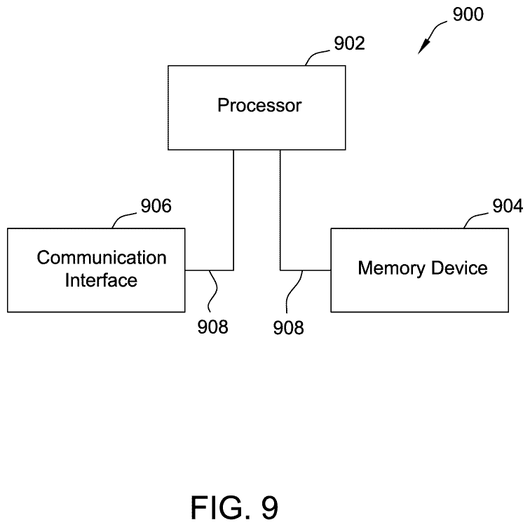

FIG. 9 is a block diagram of an example computing device 900. Computing device 900 includes a processor 902 and a memory device 904. The processor 902 is coupled to the memory device 904 via a system bus 908. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, the memory device 904 includes one or more devices that enable information, such as executable instructions or other data (e.g., sensor data), to be stored and retrieved. Moreover, the memory device 904 includes one or more computer readable media, such as, without limitation, dynamic random access memory (DRAM), static random access memory (SRAM), a solid state disk, or a hard disk. In the example embodiment, the memory device 904 stores, without limitation, application source code, application object code, configuration data, additional input events, application states, assertion statements, validation results, or any other type of data. The computing device 900, in the example embodiment, may also include a communication interface 906 that is coupled to the processor 902 via system bus 908. Moreover, the communication interface 906 is communicatively coupled to data acquisition devices.

In the example embodiment, processor 902 may be programmed by encoding an operation using one or more executable instructions and providing the executable instructions in the memory device 904. In the example embodiment, the processor 902 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

An example technical effect of the methods, systems, and apparatus described herein includes at least one of: (a) controlling an autonomous vehicle to avoid entering closed portions of a road by identifying one or more objects as forming a barrier (b) enabling an autonomous vehicle to proceed in situations where all forward travel lanes of a road are at least partially blocked by identifying an alternative travel path, or (c) improving safety and predictability of autonomous vehicle behavior by enabling an autonomous vehicle to proceed in situations where all forward travel lanes of a road are at least partially blocked.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A path determination system comprising a processor and a memory, the processor configured to:
receive sensor data from one or more sensors of an autonomous vehicle;
identify, based on the sensor data, (i) one or more forward travel lanes and (ii) one or more objects;
determine the one or more objects form a barrier indicating closure of all of the one or more forward travel lanes;
when the barrier indicates closure of all of the one or more forward travel lanes, determine an alternative travel path for the autonomous vehicle; and
control the autonomous vehicle to travel the alternative travel path.

2. The path determination system of claim 1, wherein the processor is further configured to control the autonomous vehicle to stop when an alternative travel path for the autonomous vehicle is not present.

3. The path determination system of claim 1, wherein the processor is further configured to:
while controlling the autonomous vehicle to travel the alternative travel path, identify an end of the closure of all of the one or more forward travel lanes; and
control the autonomous vehicle to travel in one of the one or more forward travel lanes at the end of the closure.

4. The path determination system of claim 1, wherein the processor is further configured to:
determine the one or more forward travel lanes includes a plurality of forward travel lanes; and
when the barrier indicates closure of less than all of the plurality of forward travel lanes, control the autonomous vehicle to travel in an open travel lane of the plurality of forward travel lanes.

5. The path determination system of claim 1, wherein to determine the alternative travel path for the autonomous vehicle, the processor is configured to determine a road shoulder is adequate for forward travel of the autonomous vehicle.

6. The path determination system of claim 1, wherein to determine the alternative travel path for the autonomous vehicle, the processor is configured to:
identify a travel path of one or more other vehicles preceding the autonomous vehicle; and
determine the travel path of the one or more other vehicles is adequate for forward travel of the autonomous vehicle.

7. The path determination system of claim 1, wherein to determine the alternative travel path for the autonomous vehicle, the processor is configured to determine a candidate alternative travel path includes a paved portion satisfying a threshold width.

8. A method for path determination, the method comprising:
receiving sensor data from one or more sensors of an autonomous vehicle;
identifying, based on the sensor data, (i) one or more forward travel lanes and (ii) one or more objects;
determining the one or more objects form a barrier indicating closure of all of the one or more forward travel lanes;
when the barrier indicates closure of all of the one or more forward travel lanes, determining an alternative travel path for the autonomous vehicle; and
controlling the autonomous vehicle to travel the alternative travel path.

9. The method of claim 8, further comprising the autonomous vehicle to stop when an alternative travel path for the autonomous vehicle is not present.

10. The method of claim 8, further comprising:
while controlling the autonomous vehicle to travel the alternative travel path, identify an end of the closure of all of the one or more forward travel lanes; and
control the autonomous vehicle to travel in one of the one or more forward travel lanes at the end of the closure.

11. The method of claim 8, further comprising:
determine the one or more forward travel lanes includes a plurality of forward travel lanes; and
when the barrier indicates closure of less than all of the plurality of forward travel lanes, control the autonomous vehicle to travel in an open travel lane of the plurality of forward travel lanes.

12. The method of claim 8, wherein determining the alternative travel path for the autonomous vehicle comprises determining a road shoulder is adequate for forward travel of the autonomous vehicle.

13. The method of claim 8, wherein determining the alternative travel path for the autonomous vehicle comprises:
identifying a travel path of one or more other vehicles preceding the autonomous vehicle; and
determining the travel path of the one or more other vehicles is adequate for forward travel of the autonomous vehicle.

14. The method of claim 8, wherein determining the alternative travel path for the autonomous vehicle comprises determining a candidate alternative travel path includes a paved portion satisfying a threshold width.

15. An autonomous vehicle comprising:
one or more sensors; and
a path determination system comprising a processor and a memory, the processor configured to:
receive sensor data from the one or more sensors;
identify, based on the sensor data, (i) one or more forward travel lanes and (ii) one or more objects;
determine the one or more objects form a barrier indicating closure of all of the one or more forward travel lanes;
when the barrier indicates closure of all of the one or more forward travel lanes, determine an alternative travel path for the autonomous vehicle; and
control the autonomous vehicle to travel the alternative travel path.

16. The autonomous vehicle of claim 15, wherein the processor is further configured to control the autonomous vehicle to stop when an alternative travel path for the autonomous vehicle is not present.

17. The autonomous vehicle of claim 15, wherein the processor is further configured to:
while controlling the autonomous vehicle to travel the alternative travel path, identify an end of the closure of all of the one or more forward travel lanes; and
control the autonomous vehicle to travel in one of the one or more forward travel lanes at the end of the closure.

18. The autonomous vehicle of claim 15, wherein the processor is further configured to:
determine the one or more forward travel lanes includes a plurality of forward travel lanes; and
when the barrier indicates closure of less than all of the plurality of forward travel lanes, control the autonomous vehicle to travel in an open travel lane of the plurality of forward travel lanes.

19. The autonomous vehicle of claim 15, wherein to determine the alternative travel path for the autonomous vehicle, the processor is configured to determine a road shoulder is adequate for forward travel of the autonomous vehicle.

20. The autonomous vehicle of claim 15, wherein to determine the alternative travel path for the autonomous vehicle, the processor is configured to:
identify a travel path of one or more other vehicles preceding the autonomous vehicle; and
determine the travel path of the one or more other vehicles is adequate for forward travel of the autonomous vehicle.
